(19) United States
(12) Patent Application Publication
(10) Pub. No.: US 2021/0012674 A1
(43) Pub. Date: Jan. 14, 2021

(54) DEVICE AND METHOD FOR DETERMINING A SAFE AIRCRAFT RUNWAY DISTANCE

(71) Applicant: Kaunas University of Technology, Kaunas (LT)

(72) Inventors: Darijus Pagodinas, Kaunas (LT); Vytautas DUMBRAVA, Kaunas (LT)

(73) Assignee: Kaunas University of Technology, Kaunas (LT)

(21) Appl. No.: 16/977,822

(22) PCT Filed: Jan. 31, 2019
(86) PCT No.: PCT/IB2019/050773

§ 371 Date: Sep. 3, 2020

(30) Foreign Application Priority Data
Mar. 5, 2018 (LT) 2018 509

(51) Int. Cl. G08G 5/06; G08G 5/00

(52) U.S. Cl. CPC G08G 5/065; G08G 5/0021

(57) ABSTRACT

The summary of the present invention is a portable autonomous device and method operating independently of the aircraft flight control equipment. The device can be easily moved from one aircraft to another. The device measures the acceleration of the aircraft from the instantaneous speed and the runway distance covered from the start of the acceleration. Once the runway length and take-off speed is input, the device calculates the remaining distance to safely reach the take-off speed. If the remaining runway distance is not enough for the safe take-off, the device provides visual or audible information about the situation and signals to the pilot. In other embodiments, the determination and presentation of the remaining runway length may be implemented in the aircraft flight control equipment.

This application is the U.S. national phase of International Application No. PCT/IB2019/050773 filed Jan. 31, 2019 which designated the U.S. and claims priority to LT Patent Application No. LT2018 509 filed Mar. 5, 2018, the entire contents of each of which are hereby incorporated by reference.

### TECHNICAL FIELD

The invention relates to a field of measuring instruments and, in particular, a measuring device and method for determining whether a runway is enough long for an accelerating aircraft to reach the required speed and take off.

### THE RELATED ART

This invention provides a device and method implemented in the device which is designed to prevent a situation when an aircraft pilot cannot assess whether the runway is long enough for the aircraft to reach the required speed and take off. The acceleration of the aircraft, which is used to determine an instantaneous speed and position of the aircraft on the runway, is continuously measured. Once the length of the runway is input, the critical length of the runway is calculated, after overcoming it, without reaching the required speed, the device informs the pilot about the current situation. In one of cases, the same device with the system can generate a second signal after which it is necessary to start stopping the aircraft in order that the remaining runway would be enough to stop the aircraft. The device provided can be separate, not integrated in the equipment of the aircraft, autonomous, portable, easy to move from one aircraft to another. The method is accurate, suitable for small aircrafts and short runways.

U.S. Pat. No. 6,711,479B1 (published on 23 Mar. 2004) provides an aircraft acceleration monitor system based on GPS signals. This system is not accurate enough when it is used in smaller aircrafts, on shorter runways, and requires a strong GPS signal, GPS receivers usually use a lot of energy. There is no mention whether the device may be autonomous, i.e. can be used in different aircrafts.

U.S. Pat. No. 4,454,582A (published on 12 Jun. 1984) describes an aircraft landing and take-off system and method for determining the time remaining until a proper take-off or landing of an aircraft according to the remaining runway distance. The system uses information about the current position of the aircraft on the runway, its speed, the maximum possible change in its speed and determines the remaining time for the decision. The cited document does not mention the way data is measured, what sensors are used, so the accuracy of the described method cannot be determined, which is very important for small aircrafts and short runways. No mention whether the device can be separated from the aircraft system, i.e. can be autonomous; this feature allows the use of such device in different aircrafts without such systems.

Summarizing the provided related art, the following deficiencies are found:
the device is not accurate enough to be used for short runways;
it is not possible to easily move the device from one aircraft to another, the device is linked to the aircraft.

This invention provides a technical solution that does not have the above deficiencies.

### THE SUMMARY OF THE INVENTION

The summary of the present invention is a portable autonomous device and method operating independently of an aircraft flight control equipment. The device can be easily moved from one aircraft to another. The device measures the acceleration of the aircraft, instantaneous speed and the runway distance from the start of the acceleration. Once the runway length and land take-off speed are input, the device calculates the remaining distance to safely reach the take-off speed. If the remaining runway distance is not enough for the safe take-off, the device provides visual or audible information about the situation and signals to the pilot. In other embodiments, the determination and presentation of the remaining runway length may be implemented in the aircraft flight control equipment.

### THE PREFFERED EMBODIMENTS

This invention provides a device and method for determining the position of the aircraft accelerating on the runway, and the information whether the remaining runway length is enough for the aircraft to reach the required take-off speed and take off in the air. The information provided is presented to the pilot in various ways.

In one of the embodiments, the device that provides the position of the aircraft on the runway and informs the pilot, is a separate aircraft device equipped with a special software that implements a distance determination method and informs the pilot. Said device is an electronic device having different memory modules for data acquisition, processor(s) for data processing, data input and output means, communication means, sensors and other equipment needed to achieve the said result. The said device must have an accelerometer or other means capable of accurately measuring the acceleration of the device. The said device has software that implements the provided method.

In order to accurately determine the position of the aircraft on the runway, in the embodiment of the present invention, the following data are additionally required for data input:
runway length;
take off direction with respect to World Countries (or other coordinate system);
wind direction with respect to World Countries (or other coordinate system);
wind speed;
take-off speed V1 of the aircraft.

The method used in the device uses input data and data on the continuously measured acceleration. The instantaneous speed with respect to the runway is determined using the first acceleration integral with respect to time, v=∫₀^{t}a [symbol] t+v₀. In other embodiments, a different method for determining the instantaneous speed may be used. Using the input data and after determining the instantaneous speed, it is possible to determine the position of the aircraft on the runway (the second acceleration integral with respect to time or another method is used, l=∫₀^{t}v [symbol] t+l₀). After determining the current position of the aircraft on the runway and evaluating the instantaneous speed with respect to air (data are manually input), the required distance for the aircraft to reach the required speed with respect to air in order to take off is calculated. The calculated distance required for the aircraft to take off is compared to the remaining runway distance. If the calculated distance is not enough for the aircraft to reach the take-off speed V1, a signal is output to a pilot. The signal to the pilot may be audible, may be visual information indicating the remaining runway is too short. In other embodiments, the method may also use the above data to calculate the distance required for the aircraft to completely stop at a given instantaneous speed. In this case, when the aircraft is running on the runway, the critical remaining distance is reached, when the pilot should start stopping to avoid an accident. At this point, the pilot is given a different kind of audible or visual signal indicating a high (increasing) probability of an accident.

In order to provide the most accurate information on the position of the aircraft on the runway, said settings of the position are carried out continuously, cyclically re-evaluating the instantaneous acceleration, instantaneous speed with respect to air, the position on the runway, remaining runway distance to achieve the required take-off speed, and so on.

In other embodiment, the described method to determine the position of the aircraft on the runway can be realized without a separate device, i.e. the method can be realized in the inner flight control systems of the aircraft using data measured by sensors arranged in the aircraft. The information for the pilot is also provided with the help of the indicators arranged in the aircraft.

In other embodiment of the invention, the position of the aircraft on the runway is determined using a flight control equipment, by installing a software implementing the other method for determining the position on the runway within it. In order to determine the position of the aircraft on the runway using this method, the data on the acceleration of the aircraft from the accelerometer, the instantaneous speed with respect to air from the Pitot tube, the profiles of speeds of the aircraft with respect to air determined and installed by the aircraft manufacturer at each point of the runway length are required. The data on the instantaneous speed of the aircraft are obtained by converting the instantaneous acceleration to the speed, and the speed of the aircraft with respect to air is obtained by measuring static and dynamic pressures using the Pitot tube. After determining the speed, the position of the aircraft on the runway can be determined. After determining the position of the aircraft on the runway and the current speed with respect to air, these data are compared with the speed profiles installed by manufacturers for each point of the length of the runway. If the determined speed of the aircraft with respect to air is lower than that specified by profiles provided by the manufacturer, an audible or visual signal is generated and output to the pilot.

In other embodiment of the present invention, the electronic device described above, which is separate from the aircraft control equipment and has an accelerometer, is used. After measuring the acceleration, the instantaneous speed and position on the runway is determined. Once the length of the runway has been input and the position of the aircraft on the runway is determined, the remaining distance of the runway for the aircraft to safely reach the take-off speed V1 can be determined. In order to determine the remaining runway distance for the safe take-off, artificial intelligence means collecting and processing information on the dependency of the value of the speed V1 of the specific aircraft enough to take off on the position of the aircraft on the runway. Once the length of the specific runway is input, when measuring the acceleration (from which the speed and the position on the runway are recalculated), the remaining distance for the safe take-off can be determined. After comparing the determined speed and position on the runway to the values generated by the artificial intelligence, it is determined whether the remaining runway distance is enough for the safe take-off.

The described device and method are useful and convenient in that when measuring the actual instantaneous speed, a number of factors that determine the acceleration of the aircraft (e. g. the nature of the runway pavement, the hardness of the pavement, some of the described embodiments evaluate environmental conditions (wind influence, etc.) are evaluated.

In order to illustrate and describe the invention, the description of the preferred embodiments is presented above. This is not a detailed or restrictive description to determine the exact form or embodiment. The above description should be viewed more than the illustration, not as a restriction. It is obvious that specialists in this field can have many modifications and variations. The embodiment is chosen and described in order to best understand the principles of the present invention and their best practical application for the various embodiments with different modifications suitable for a specific use or implementation adaptation. It is intended that the scope of the invention is defined by the definition added to it and its equivalents, in which all of these definitions have meaning within the broadest limits, unless otherwise stated.

In the embodiments described by those skilled in the art, modifications may be made without deviating from the scope of this invention as defined in the following definition.

1. (canceled)

2. (canceled)

3. (canceled)

4. (canceled)

5. (canceled)

6. (canceled)

7. (canceled)

8. A method for determining a safe aircraft runway distance based on input of runway length, take-off direction with respect to the World Countries (or other coordinate system), wind direction with respect to the World Countries (or other coordinate system), wind speed, and take-off speed, V1, of an aircraft, comprising the following steps:
measuring acceleration of an aircraft at continuous intervals using an accelerometer;
determining an instantaneous speed of an aircraft using the first acceleration integral with respect to time using a computer processor;
determining a position of the aircraft on a runway using the second acceleration integral with respect to time using a computer processor;
determining the remaining runway distance for reaching the take-off speed, V1, of an aircraft by comparing the instantaneous speed of the aircraft with respect to air with the take-off speed, V1;
providing output to a pilot if the remaining runway is no longer enough to reach the take-off speed, V1.

9. A method for determining a safe aircraft runway distance according to claim 8, further comprising the step of determining the value of the take-off speed, V1, of the aircraft according to an aircraft manufacturer speed profile along a runway and input runway length implemented in a processing device.

10. A method for determining a safe aircraft runway distance according to claim 8, wherein the data required as input are a runway length and a value of take-off speed, V1, of an aircraft.

11. A method for determining a safe aircraft runway distance according to claim 8, further comprising determining the instantaneous speed of an aircraft with respect to air using a Pitot tube.

12. A device for use in determining a safe aircraft runway distance, comprising different memory modules for data acquisition, processor(s) for data processing, data input and output means, communication devices, sensors, and other device units;
further comprising an accelerometer for measuring acceleration of an aircraft.

13. A device for use in determining a safe aircraft runway distance according to claim 12, characterized in that the device is portable, autonomous, separate from a flight control equipment of an aircraft and can be easily moved from one aircraft to another.

14. A device for use in determining a safe aircraft runway distance according to claim 12, wherein a data input means and memory modules receive and store data including runway length, take-off direction with respect to the World Countries (or other coordinate system), wind direction with respect to the World Countries (or other coordinate system), wind speed, and take-off speed, V1, of an aircraft.

15. A device for use in determining a safe aircraft runway distance according to claim 12, wherein the device contains a software module to determine an instantaneous speed of an aircraft using the first acceleration integral with respect to time.

16. A device for use in determining a safe aircraft runway distance according to claim 12, wherein the device contains a software module to determine a position of an aircraft on a runway using the second acceleration integral with respect to time.

17. A device for use in determining a safe aircraft runway distance according to claim 12, wherein the device contains a software module to determine the remaining runway distance for reaching the take-off speed, V1, of an aircraft by comparing the instantaneous speed of an aircraft with respect to air with the take-off speed, V1.

18. A device for use in determining a safe aircraft runway distance according to claim 12, wherein output means and communication devices provide output to a pilot if the remaining runway is no longer enough to reach the take-off speed, V1.

19. A device for use in determining a safe aircraft runway distance according to claim 12, wherein the device contains a software module to determine the value of the take-off speed, V1, of an aircraft according to an aircraft manufacturer speed profile along a runway and input runway length.

20. A device for use in determining a safe aircraft runway distance according to claim 12, wherein another device is a Pitot tube for use in determining the instantaneous speed of an aircraft with respect to air.
